(19) United States
(12) Patent Application Publication
(10) Pub. No.: US 2011/0161336 A1
(43) Pub. Date: Jun. 30, 2011

(54) SEARCH SUPPORTING DEVICE AND A METHOD FOR SEARCH SUPPORTING

(75) Inventors: Satoko SHIGA, Kawasaki (JP); Tomoya IWAKURA, Kawasaki (JP); Takahisa ANDO, Kawasaki (JP); Seishi OKAMOTO, Kawasaki (JP)

(73) Assignee: FUJITSU LIMITED, Kawasaki (JP)

(21) Appl. No.: 12/968,947

(22) Filed: Dec. 15, 2010

(30) Foreign Application Priority Data
Dec. 28, 2009 (JP) 2009-296732

(51) Int. Cl. G06F 17/30

(52) U.S. Cl. 707/758; 707/E17.108

(57) ABSTRACT

A search supporting device includes an accepting unit for accepting an input word and a URL, a log obtaining unit for obtaining from a search log storing unit in which a log including a search word having been used for every URL of viewed data for a search of the data is stored, the log including a URL having a particular portion in common with the accepted URL and a search word having a particular portion in common with the accepted input word, and an outputting unit for outputting the search word included in the obtained log.

### CROSS-REFERENCE TO RELATED APPLICATIONS

This application is based upon and claims the benefit of priority of the prior Japanese Patent Application No. 2009-296732, filed on Dec. 28, 2009, the entire contents of which are incorporated herein by reference.

### FIELD

Various embodiments described herein relate to a search supporting device and a method for search supporting.

### BACKGROUND

Upon being provided with a keyword, an ordinary search engine (a Website which provides a keyword search function) on the Internet presents a word related to the keyword as a candidate for an extra keyword to be added (called “expanded keyword” hereafter). A word to be presented as an expanded keyword is chosen on the basis of a log recorded, e.g., when two or more keywords were simultaneously input in the past. For example, if keywords such as “Chinese dish, recipe”, “Chinese dish, Central Plain Hotel”, “Chinese dish, Yum cha”, “Chinese dish, history”, etc. and the word “Chinese dish” is input as a keyword, the words such as “recipe”, “Central Plain Hotel”, “Yum cha”, “history”, etc. are counted as candidates for expanded keywords.

A method for searching for information which enables a particular user to search for the information in a manner in which his or her preference is reflected is typical, e.g., as discussed in Japanese Laid-open Patent Publication No. 2004-259083.

A method for searching for information by causing the information to be recalled on the basis of the information viewed in the past is typical, e.g., as discussed in Japanese Laid-open Patent Publication No. 2004-54918.

A method for searching for information which provides a user with a keyword for the search expanded from a keyword input by the user into more natural expression close to the user's purpose for the search is typical, e.g., as discussed in Japanese Laid-open Patent Publication No. 2007-133688.

### SUMMARY

According to an aspect of the invention, a search supporting device includes an accepting unit for accepting an input word and a URL, a log obtaining unit for obtaining from a search log storing unit a log including a search word having been used for every URL of viewed data for a search of the data, the log including a URL having a particular portion in common with the accepted URL and a search word having a particular portion in common with the accepted input word, and an outputting unit for outputting the search word included in the obtained log.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed. Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an exemplary configuration of a search system of an embodiment of the present invention.

FIG. 2 illustrates an exemplary hardware configuration of a search server of an embodiment of the present invention.

FIG. 3 is a flowchart for explaining a procedure of a process of an embodiment for recording a search log.

FIG. 4 illustrates an exemplary display of a search page.

FIG. 5 illustrates an exemplary display of a search result page.

FIG. 6 illustrates an exemplary configuration of a search log storing unit of an embodiment.

FIG. 7 is a flowchart for explaining a procedure of a process of an embodiment for classifying a search log.

FIG. 8 illustrates an exemplary configuration of a classified search log storing unit of an embodiment.

FIG. 9 is a flowchart for explaining a procedure of a process of an embodiment for choosing an expanded keyword.

FIG. 10 specifically illustrates a process of an embodiment for choosing an expanded keyword.

FIG. 11 illustrates an exemplary method of an embodiment for providing expanded keywords.

FIG. 12 illustrates an exemplary method of an embodiment for providing expanded keywords.

FIG. 13 is a flowchart for explaining a procedure of a process of an embodiment for choosing an expanded keyword.

FIG. 14 illustrates an exemplary method of an embodiment for providing an expanded keyword.

FIG. 15 illustrates an exemplary user interface which enables a user to choose a field to be searched.

FIG. 16 illustrates an exemplary configuration of a search log storing unit of an embodiment.

FIG. 17 illustrates an exemplary configuration of a classified search log storing unit of an embodiment.

FIG. 18 is a flowchart for illustrating a procedure of a process of an embodiment for classifying a group set.

FIG. 19 illustrates an exemplary session ID and keyword combination list.

FIG. 20 illustrates an exemplary identical search list.

FIG. 21 illustrates an exemplary configuration of a group set identifying table.

FIG. 22 is a flowchart for explaining a procedure of a process of an embodiment for choosing an expanded keyword.

FIG. 23 is a flowchart for explaining a procedure of a group set identifying process.

### DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Generally, a word input as a keyword for a search is combined with words in various fields depending upon a purpose of the search. The single keyword combined with the words in various fields is resultantly accumulated as a log. If candidates for an expanded keyword are simply chosen on the basis of such a log, there is a problem in that the chosen candidates can include a word which belongs to a field related little to the user's purpose of the search. To put it specifically, if a word “Chinese dish” is input as a keyword, an expanded keyword to be added is supposed to change depending upon the purpose such as cooking, searching for a restaurant or studying history. If a word in every field input together with “Chinese dish” in the past is nonetheless counted as a candidate for the expanded keyword to be added to “Chinese dish”, an effect of enhancing operability by presenting the expanded keyword can be reduced. The expanded keyword may modify an input search keyword to enable accurate retrieval of data relevant to the input search keyword.

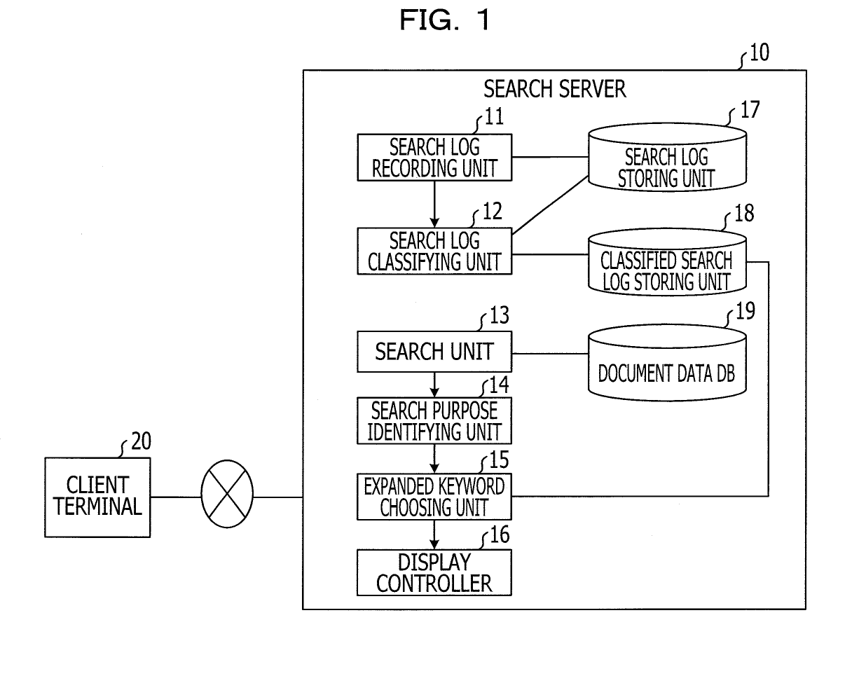

An embodiment of the present invention will be explained below with reference to the drawings. FIG. 1 illustrates an exemplary configuration of a search system of an embodiment of the present invention. In FIG. 1, a search server 10 is connected to a client terminal 20 via a network such as the Internet so that they can communicate with each other.

The client terminal 20 is an electronic device to be used by a user, such as a PC (Personal Computer) or a mobile terminal. The client terminal 20 of the embodiment has a Web browser which transmits a search request to the search server 10 and displays a search result transmitted back in response to the search request. Incidentally, the search system can include a plurality of client terminals 20.

The search server 10 is a computer having a function for providing a Website as a search engine on the Internet. As illustrated in FIG. 1, the search server 10 has a search log recording unit 11, a search log classifying unit 12, a search unit 13, a search purpose identifying unit 14, an expanded keyword choosing unit 15, a display controller 16, a search log storing unit 17, a classified search log storing unit 18 and a document data DB 19. A CPU of the search server 10 runs a program installed in the search server 10 so that the above portions of the search server 10 are implemented.

The search log recording unit 11 records history data indicating a user's operation relative to a search (called the “search log” hereafter) in the search log storing unit 17. The search log is data including a URL (Uniform Resource Locator) of viewed data and a search word used for the search for the data. In other words, the search log includes the input search keyword (search word) and data indicating which part of a search result has been chosen as a linked page or a destination of transition (i.e., an object to be viewed) (linked URL).

The search log storing unit 17 is a memory area in which search logs are stored in an auxiliary storage device 102. The search log classifying unit 12 classifies the search logs recorded on the search log storing unit 17 depending upon a common feature of linked URLs. The search log classifying unit 12, e.g., gathers search logs having a common particular portion (content) of the linked URLs into a same group, and records a classified result in the classified search log storing unit 18. The classified search log storing unit 18 is a memory area in which classified results of search logs are stored in the auxiliary storage device 102. The search unit 13 searches the document data DB 19 on the basis of a search keyword. The document data DB 19 is a database for storing index data, etc., of information disclosed on the Internet by using the auxiliary storage device 102. The search purpose identifying unit 14 identifies or estimates a purpose of a user who does a search (search purpose). The expanded keyword choosing unit 15 chooses an expanded keyword in accordance with the user's search purpose. The expanded keyword of the embodiment is an extra character string (including a single character) to be added as a search keyword. The expanded keyword is used so that a search area can be limited in accordance with the search purpose and that a search result can be obtained in line with the search purpose. The display controller 16 produces a screen (Web page) on which a search keyword can be input, a screen (Web page) on which a search result can be displayed, etc., and transfers the screens to the client terminal 20, etc.

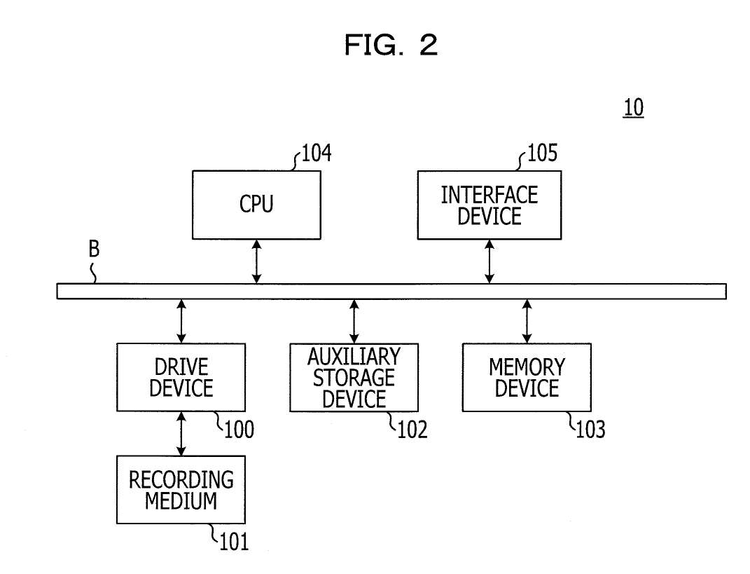

FIG. 2 illustrates an exemplary hardware configuration of a search server of an embodiment of the present invention. The search server 10 illustrated in FIG. 2 has a drive device 100, the auxiliary storage device 102, a memory device 103, a CPU 104 and an interface device 105 which are connected to one another by a bus B.

The program which implements a process on the search server 10 is provided by, for example, a recording medium 101 such as a CD-ROM. If the recording medium 101 on which the program is recorded is set in the drive device 100, the program is installed from the recording medium 101, via the drive device 100, into the auxiliary storage device 102. Incidentally, the program is not necessarily installed from the recording medium 101, and can suitably be downloaded from another computer via the network. The installed program is stored in the auxiliary storage device 102, and so are necessary files, data, etc.

In case of instructions to activate the program, the memory device 103 reads the program from the auxiliary storage device 102 and stores the program in itself. The CPU 104 carries out functions of the search server 10 in accordance with the program stored in the memory device 103. The interface device 105 is used as an interface connected to the network.

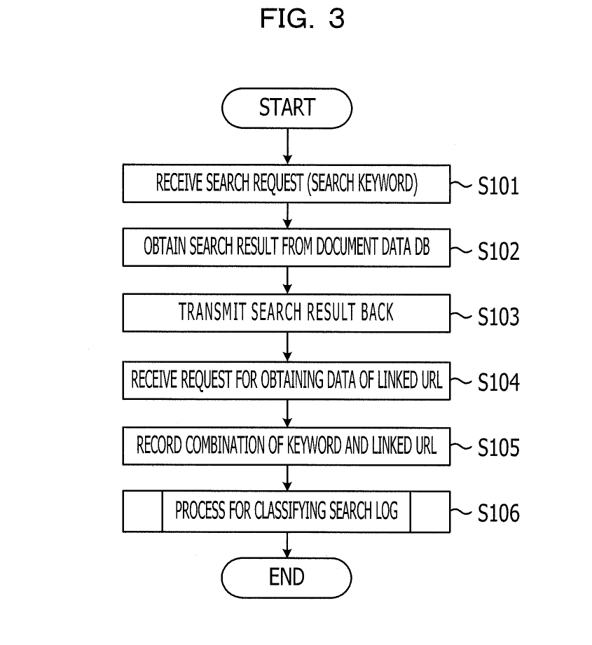

A procedure of a process of the search system will be explained below. FIG. 3 is a flowchart for explaining a procedure of a process of an embodiment for recording a search log.

The search unit 13 of the search server receives a search request including a search keyword from the Web browser of the client terminal 20 (S101).

The search unit 13 records the search keyword in the memory device 103 in connection with a session ID for distinguishing sessions with the Web browser and time data. Data for distinguishing individual Web browsers can be used instead of the session ID. Further, while specific examples of identifying data and sessions are explained, the present invention is not limited thereto. For example, any identifier uniquely specifying a session, data or time may be utilized.

Incidentally, the search keyword is input via a search page provided by the search server 10 to the Web browser of the client terminal 20 before the operation S101 is carried out.

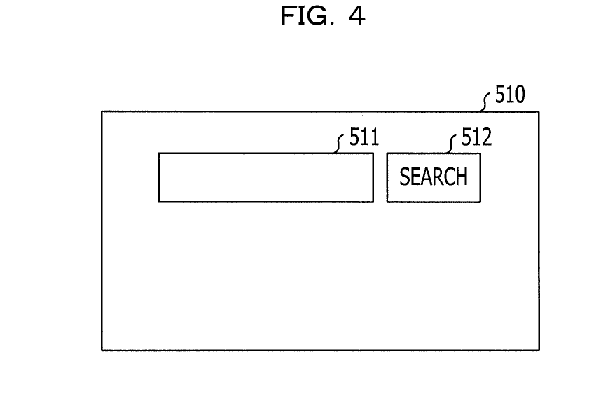

FIG. 4 illustrates an exemplary display of the search page. The search page 510 illustrated in FIG. 4 has a keyword input area 511, a search button 512, etc. If a search keyword is input in the keyword input area 511 and the search button 512 is clicked, the Web browser transmits a search request including the input search keyword to the search server 10. Incidentally, the search keyword is a character string including one word or more. If, e.g., a plurality of words separated by a space, etc., is input in the keyword input area, a character string including the plural words is received as a search keyword at the operation S101.

Then, the search unit 13 searches the document data DB 19 on the basis of the search keyword, and outputs a search result (S102). The search result may include a URL for every piece of information, e.g., disclosed on the Internet. The search system can rely on typical processing and operation concerning how to handle search logic or relations among plural words (a logical product or a logical sum, etc.) included in plural search keywords.

Then, the display controller 16 produces a Web page on which the search result obtained by the search unit 13 is displayed (called the “search result page” hereafter), and transmits the search result page back to the Web browser (S103). The search result page is resultantly displayed on the Web browser of the client terminal 20.

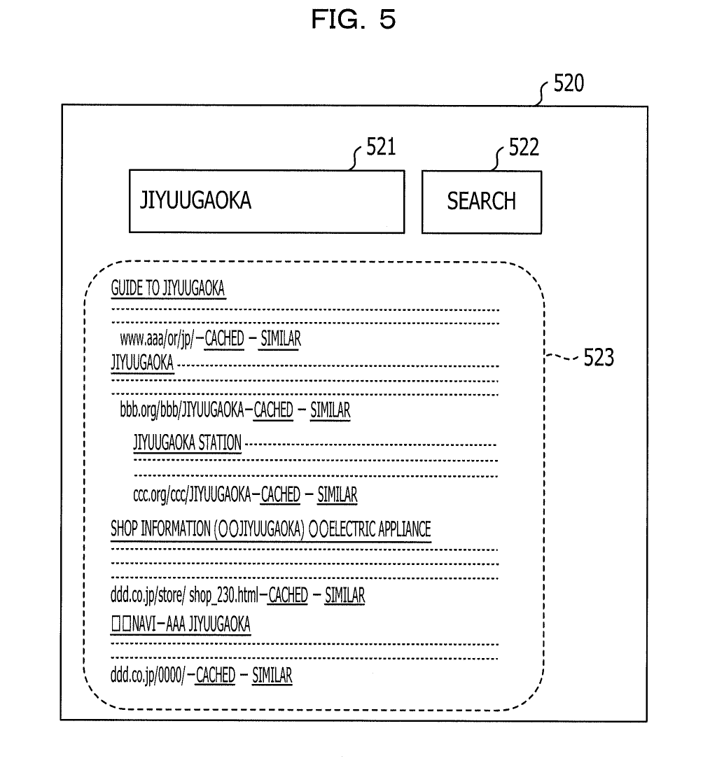

FIG. 5 illustrates an exemplary display of a search result page. In FIG. 5, the search result page 520 has a keyword input area 521, a search button 522, a search result display area 523, etc. In the keyword input area 521, the search keyword input in the keyword input area 511 in the search page 510 (FIG. 4) is being displayed. A user can change the search keyword in the keyword input area 521 and click the search button 522 so as to redo a search. In the search result display area 523, a list of searched data items is displayed. Each one of the data items is provided with a link (hyperlink) to a URL of the relevant data item.

Then, if the user clicks (chooses) one of the links on the search result page 520, the Web browser transmits a request for obtaining a data item distinguished by the URL set to the clicked link. The search log recording unit 11 of the search server 10 receives the request for obtaining the data item (S104). Incidentally, the search system can rely on typical processing and operation concerning a mechanism such that the request for obtaining the data item is transmitted not to the URL set to the clicked link (linked URL) but to the search server 10.

Then, the search log recording unit 11 of the search server 10 records the search keyword and the linked URL included in the request for obtaining the data item in connection with each other on the search log storing unit 17 (S105). The search keyword recorded at this moment is what is recoded on a RAM 113 in connection with a session ID and time data included in the request for obtaining the data item.

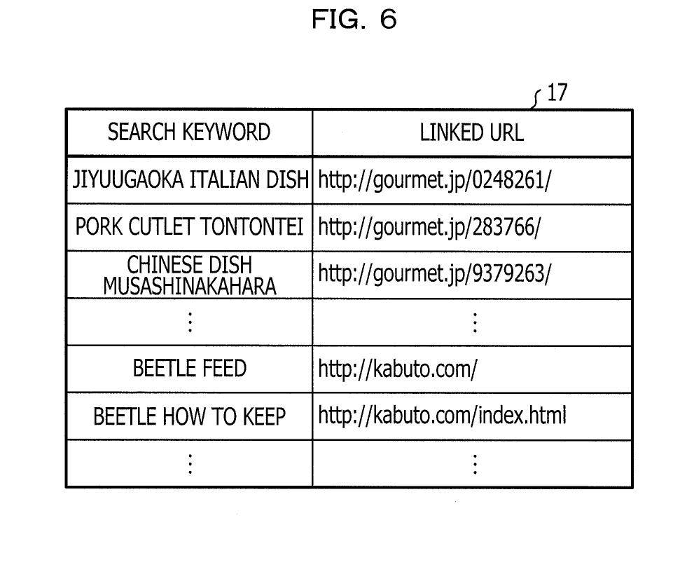

FIG. 6 illustrates an exemplary configuration of the search log storing unit of an embodiment. As illustrated in FIG. 6, the search log storing unit 17 stores information concerning a search carried out in the past where a combination of a search keyword and a linked URL as a search log. If a plurality of words is included in the search keyword as illustrated in FIG. 6, the individual words are separated by spaces.

Then, the search log classifying unit 12 carries out a process for classifying a search log added anew to the search log storing unit 17 (S106). The process for classifying a search log will be explained later in detail.

Incidentally, the request for obtaining the data item is transferred to the linked URL after the operations S105 and S106 are carried out or in parallel with the operations S105 and S106. A data item distinguished by the URL (e.g., a Webpage) is transmitted back to the Web browser in response to the request for obtaining the data item.

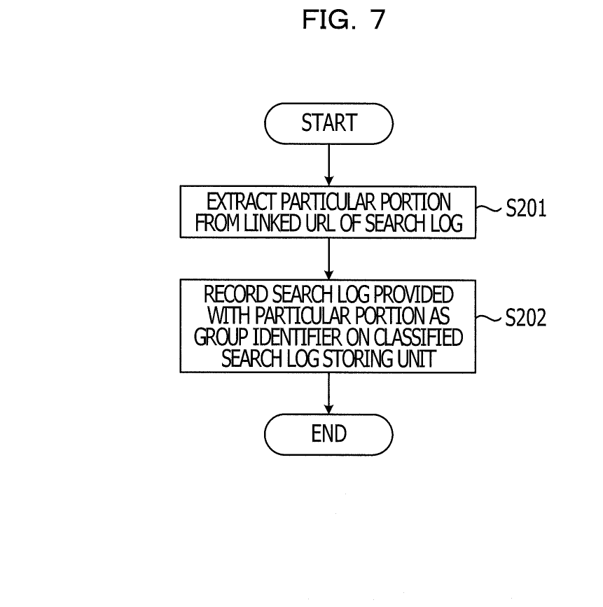

Then, the operation S106 carried out by the search log classifying unit 12 illustrated in FIG. 3 will be explained in detail. FIG. 7 is a flowchart for explaining a procedure of a process of an embodiment for classifying a search log.

The search log classifying unit 12 extracts a particular portion (e.g., an upper portion) of the search log recorded anew at the operation S105 illustrated in FIG. 3 (S201).

Assume here that a host name is extracted as the particular portion. Then, the search log classifying unit 12 records the search log provided with the extracted host name as a group identifier on the classified search log storing unit 18 (S202). Incidentally, the group identifier is used as data for identifying different groups into which search logs are classified. A reason for this is to distinguish between data by URLs of Websites because a common feature of data contents between the Websites are generally closely dependent on a common feature of the URLs between the Websites.

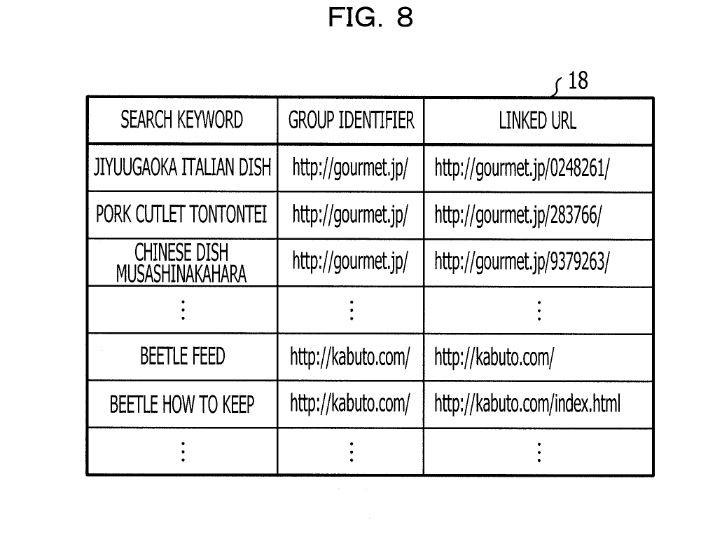

FIG. 8 illustrates an exemplary configuration of a classified search log storing unit of an embodiment. As illustrated in FIG. 8, the classified search log storing unit 18 further has an item (column) of a group identifier that the search log storing unit 17 does not have. That is, the group identifiers extracted from the linked URLs of the individual search logs are recorded on the classified search log storing unit 18 in connection with the individual search logs. The search logs are each classified into groups by being provided with the respective group identifiers. That is, search logs provided with a same (common) group identifier belong to a same group. Incidentally, although being illustrated as one table in FIG. 8, the table can be divided by every group identifier (i.e., every group). Further, the group identifier can be other than the host name of the linked URL, and can be selected in accordance with another rule such as up to the host name and a first slash symbol. Further, a typical clustering algorithm can be applied to the linked URL so that the group identifier is selected. A given keyword may be associated with more than one group identifier and/or linked URL.

The process illustrated in FIG. 7 can be carried out asynchronously with the process illustrated in FIG. 3. The classified search log storing unit 18, e.g., can periodically refer to the search log storing unit 17, and can collectively carry out the process illustrated in FIG. 7 like batch processing.

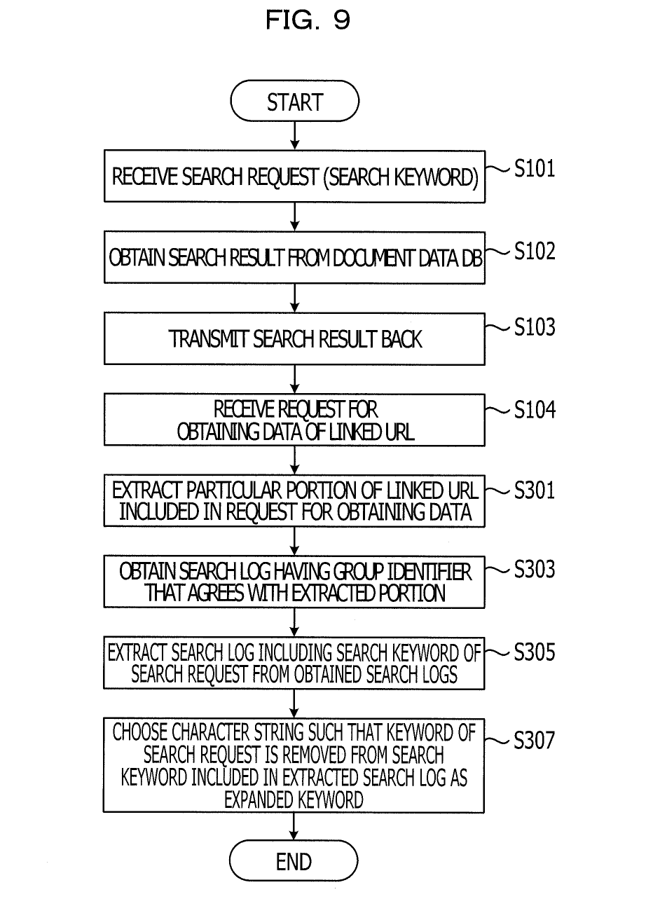

Then, a procedure of a process for choosing an expanded keyword (a candidate) for a search keyword input upon a new search being done will be explained. FIG. 9 is a flowchart for explaining a procedure of a process of an embodiment for choosing an expanded keyword. Each of operations illustrated in FIG. 9 which is a same as the corresponding one illustrated in FIG. 3 is given a same numeral, and its explanation is suitably omitted.

If the request for obtaining a data item transmitted by the Web browser in response to a click on a link in the search result page 520 is received (S104 in FIG. 9), the search purpose identifying unit 14 of the search server 10 extracts a particular portion of the linked URL included in the request for obtaining a data item (S301). A rule for extracting the particular portion may be the same as the extracting rule for the operation S201 illustrated in FIG. 7. Thus, the search purpose identifying unit 14 of the embodiment extracts a host name. The particular portion (host name) of the linked URL of the search result for this time extracted by the search purpose identifying unit 14 is used as identification data for identifying a purpose of the search for this time.

The expanded keyword choosing unit 15 obtains a search log (record) having a group identifier that agrees with the extracted host name from the classified search log storing unit 18 (S303).

In addition, a search log having a same host name as the extracted host name can be obtained from the search log storing unit 17. That is, the search log classifying unit 12 need not classify the search log (need not provide the search log with a group identifier) in advance. As the classified search log storing unit 18 is used, however, the processing speed can be enhanced.

Then, the expanded keyword choosing unit 15 extracts a search log including a search keyword specified by the search request for this time (called the “basic keyword” hereafter) from a set of the obtained search logs (S305). The basic keyword is the search keyword recorded on the memory device 103 in connection with the session ID included in the request for obtaining a data item transmitted by the Web browser as described at the operation S104. The basic keyword is recorded on the memory device 103 by the search unit 13 as explained with reference to FIG. 3. Incidentally, the basic keyword can include only one word or a plurality of words.

Then, the expanded keyword choosing unit 15 chooses as an expanded keyword a character string such that a word included in the basic keyword is removed from the search keyword included in the extracted search log (S307). The expanded keyword choosing unit 15 records the chosen expanded keyword on the memory device 103 in connection with the session ID included in the search request.

Incidentally, the process of the operations S105 and S106 illustrated in FIG. 3 is carried out as well after the operation S104 illustrated in FIG. 9. The operations S105 and S106 can be carried out before or after the operations S301, S303, S305 and S307.

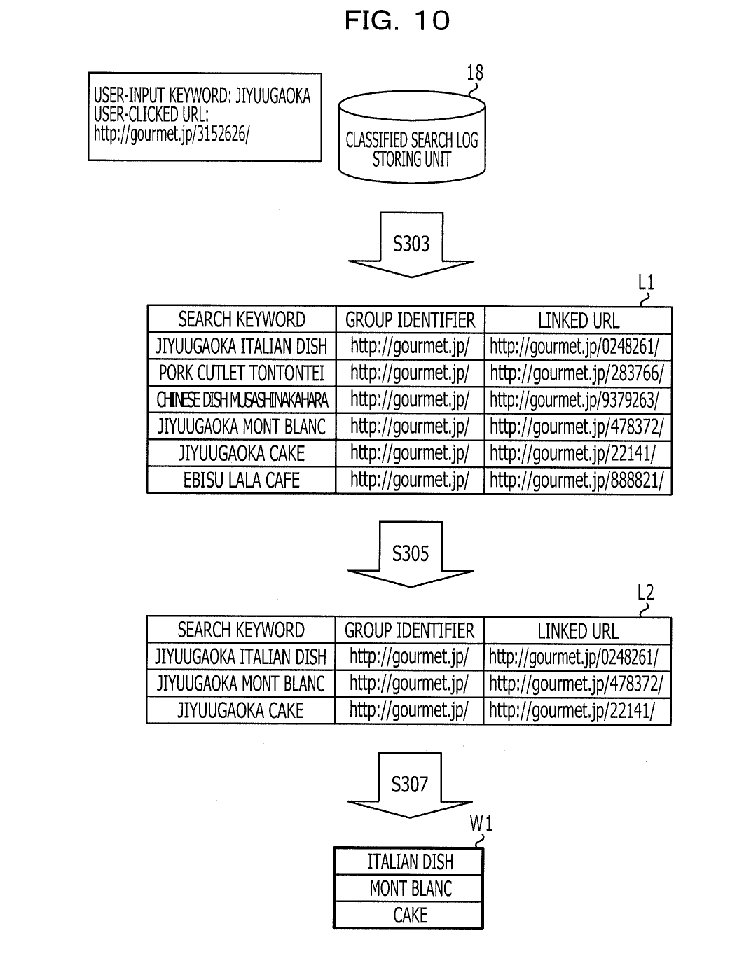

An exemplary process of the operations S301, S303, S305 and S307 will be specifically illustrated. FIG. 10 specifically illustrates an exemplary process of an embodiment for choosing an expanded keyword. Assume, as illustrated in FIG. 10, that the basic keyword is “Jiyuugaoka”(“jiyuugaoka” is place-name.). Further, assume that a linked URL searched for from “Jiyuugaoka” is “http://gourmet.jp/3152626/”. In this case, the URL “http://gourmet.jp/3152626/” is extracted from the linked URL at the operation S301. Thus, a search log group L1 provided with “http://gourmet.jp/3152626/” as a group identifier is obtained from the classified search log storing unit 18 at the operation S303. Incidentally, in FIG. 10, character strings put in block arrow symbols indicate the numerals of the operations corresponding to FIG. 9.

Then, a search log group L2 including the basic keyword “Jiyuugaoka” in the search keywords is extracted from the search log group L1 (S305). Then, a character string group W1 such that the basic keyword “Jiyuugaoka” is removed from the search keywords included in the search log group L2 is chosen as expanded keywords.

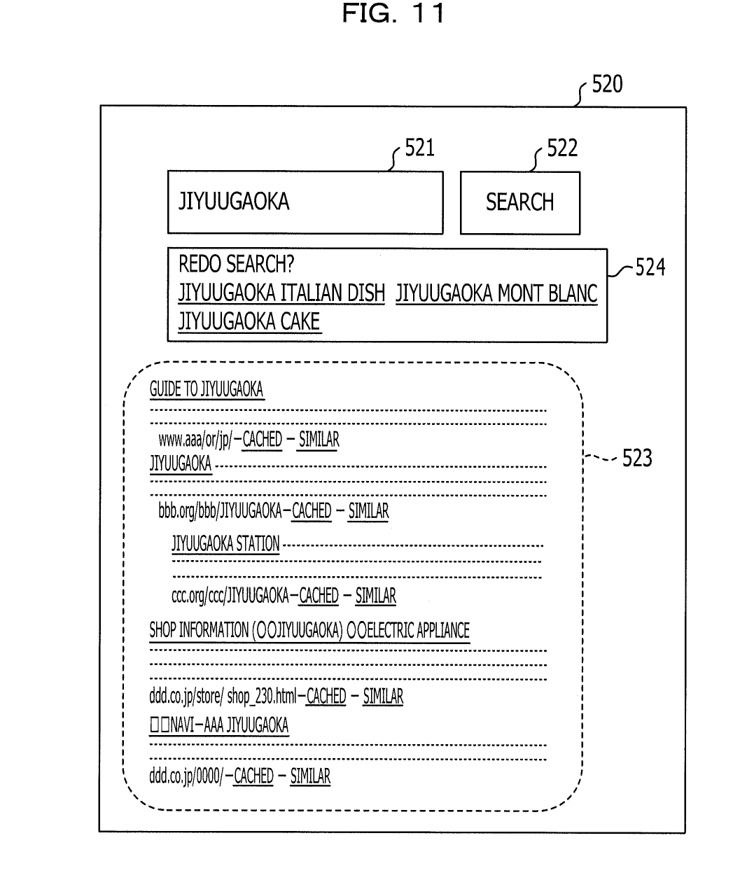

FIGS. 11, 12, 13 and 14 exemplarily illustrate how to provide the client terminal 20 with chosen expanded keyword(s). FIG. 11 illustrates a first exemplary method of an embodiment for providing the expanded keywords.

If one of the links is clicked on the search result page 520 illustrated in FIG. 5, data related to the clicked link is displayed on the Web browser. Then, if a “back” button (for displaying data previously displayed) of the Web browser is clicked, the search result page 520 is displayed in a manner illustrated in FIG. 11. The search result page 520 illustrated in FIG. 11 further has an expanded keyword display area 524. The expanded keywords chosen by the expanded keyword choosing unit 15 are each displayed in association with the basic keyword in the expanded keyword display area 524. A combination of each of the expanded keywords and the basic keyword is provided with a link for transmitting a search request based on a search keyword including the relevant expanded keyword and the basic keyword to the search server 10. In an embodiment, word(s) in the expanded keyword display area 524 may modify the meaning of the basic keyword so as to cause different results to be obtained when used.

Incidentally, if the Web browser transmits a request for redoing a search based on the basic keyword to the search server 10 in response to the click on the “back” button of the Web browser, the display controller 16 can suitably produce the search result page 520 illustrated in FIG. 11 in response to the request for redoing a search. At this moment, the display controller 16 can suitably produce the expanded keyword display area 524 on the basis of the expanded keyword and the basic keyword which are recorded on the memory device 103 in connection with the session ID included in the request for redoing a search.

Meanwhile, if the search result page 520 cached in the client terminal 20 is made and left being what is displayed by the Web browser in response to the click on the “back” button of the Web browser, the search server 10 has no chance to provide an expanded keyword. In order that such a case is dealt with, a script (e.g., Java Script (trademark)) which transmits a request for obtaining an expanded keyword in case of the display of the search result page 520 to the search server 10 can suitably be integrated in the search result page 520. If an expanded keyword exists in connection with the session ID included in the request for obtaining an expanded keyword, the expanded keyword choosing unit 15 transmits the expanded keyword back. If no expanded keyword exists in connection with the session ID, the expanded keyword choosing unit 15 transmits a reply that there is no expanded keyword. If the expanded keyword is received, the script of the search result page 520 produces the expanded keyword display area 524. If no expanded keyword is received, the script does not produce the expanded keyword display area 524.

If a new window (Web browser) is displayed in response to the click on one of the links on the search result page 520 illustrated in FIG. 5, however, the click on the “back” button is not necessarily required. A reason why is that, if the script is integrated in the search result page 520, the search result page 520 is automatically updated as illustrated in FIG. 11 while the new window is being displayed.

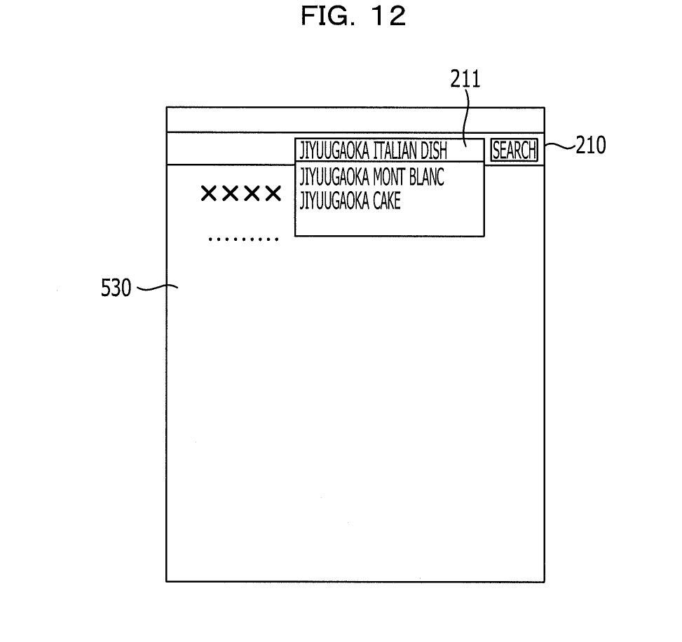

Further, FIG. 12 illustrates a second exemplary method of an embodiment for providing an expanded keyword.

As illustrated in FIG. 12, e.g., an exclusive toolbar 210 of the search server 10 is plugged in the Web browser. If one of the links is clicked on the search result page 520 and data 530 of a linked page is displayed on the Web browser in this case, the toolbar 210 transmits a request for obtaining an expanded keyword to the search server 10. If an expanded keyword exists in connection with the session ID included in the request for obtaining an expanded keyword, the expanded keyword choosing unit 15 transmits the expanded keyword back in response to the request for obtaining an expanded keyword. If no expanded keyword exists in connection with the session ID, the expanded keyword choosing unit 15 transmits a reply that there is no expanded keyword. If the expanded keyword is received, the toolbar 210 sets a list of search keywords for which the basic keyword is combined with expanded keywords in a combo box 211. The user can thereby do a search by using the added expanded keywords.

As described above, the search server 10 of an embodiment classifies past search logs depending upon a common feature of the linked URLs. Upon a search being done, the search server 10 identifies a user's purpose of the search on the basis of the linked URL chosen from the search results, and identifies an expanded keyword on the basis of a search log classified as a group according to the purpose of the search. That is, a search log to be an area in which the expanded keyword is obtained is limited on the basis of a particular portion of the linked URL chosen from the search results. As a result, the search system can dynamically provide different expanded keywords in accordance with action of the user while using the same search log. Thus, there can be better chance of providing an expanded keyword matching the user's purpose of the search.

Incidentally, the data of the linked page clicked on the search result page 520 may belong to a field which is different from data desired by the user in some cases. Thus, if, e.g., a link of a URL including the same host name (particular portion) is clicked for the number of times more than a threshold, the operations S301, S303, S305 and S307 illustrated in FIG. 9 (i.e., a choice of a candidate for an expanded keyword) can be suitably carried out. In this case, the search purpose identifying unit 14 records on the memory device 103 how many times the request for obtaining data is received for every session ID and every host name of the linked URL included in the request for obtaining data in accordance with the request for obtaining the data received in response to the click on the link on the search result page 520. If the number of times of receiving the request exceeds the threshold, the process of and after the operation S301 is carried out.

On the other hand, if the data of the linked page is viewed for more than a particular period of time, the operations S301, S303, S305 and S307 illustrated in FIG. 9 can be suitably carried out on the basis of the host name of the linked URL. In this case, the search purpose identifying unit 14 can suitably estimate a period of time between the first request for obtaining data received in response to the click on the link on the search result page 520 and the next request for obtaining data based on the same session at a first period of time for viewing data.

Incidentally, not only the common feature of the linked URLs but also time data of the search logs can be considered so that the search logs are divided into groups. If, e.g., a search is done at a lunchtime, an expanded keyword fit for lunch can thereby further be extracted and presented from expanded keywords narrowed down to data as to eating. In this case, the time data (when the search is done) is further recorded on the search log. In order to present the expanded keyword, suitably narrow down the search log on the basis of the group identifier of the linked URL and extract on the basis of the current time (time of clicking) a search log having time data within a regular interval since the current time.

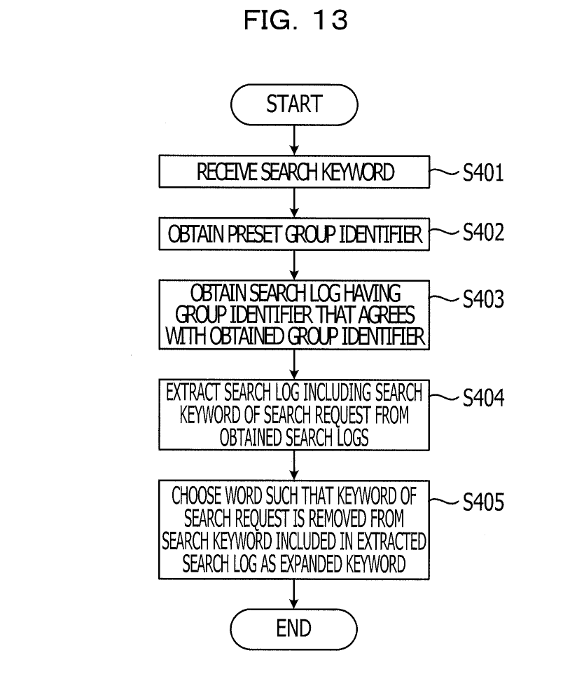

Then, an embodiment will be explained. What is not mentioned in particular as to an embodiment can be the same as what is mentioned as to the above-described embodiment. The search purpose identifying unit 14 of an embodiment identifies a purpose of a search in a different way. That is, the process illustrated in FIG. 9 is replaced with a process illustrated in FIG. 13.

FIG. 13 is a flowchart for explaining a procedure of a process of an embodiment for choosing an expanded keyword.

The search unit 13 receives a search keyword from the Web browser of the client terminal 20. The chance of this process can be based on a search request similarly as in FIG. 9, etc., or can be other than that. It is enough that the search keyword is received at least. That will be explained below in detail (S401).

The search purpose identifying unit 14 obtains a group identifier (host name) which is preset and recorded on the auxiliary storage device 102 (S402). The expanded keyword choosing unit 15 obtains a search log (record) having a group identifier that agrees with the obtained group identifier from the classified search log storing unit 18 (S403). Following operations S404 and S405 are same as the operations S305 and S307, respectively.

That is, according to an embodiment, not the particular portion of the URL set on the link chosen on the search result page 520 but the preset group identifier is used as data to limit the area from which the expanded keyword is obtained. Such a configuration is effective particularly in a case where the search server 10 is a search engine adapted for a certain field (e.g., a Website for doing a search as to eating). A reason why is that the preset group identifier related to the relevant field enables an expanded keyword related to the relevant field to be presented.

Further, an embodiment is effective in a case where a new special search service is built as well. If, e.g., enough time has passed after an eating-specific search service was built, eating-specific search keywords are probably being accumulated on a search log recorded by the eating-specific search service. The above-mentioned embodiment can be implemented after the search log is accumulated. There is no search log, however, when a new service is built. Thus, external search logs for a generic search can be used and the search logs can be classified in line with the embodiment so that an expanded keyword for a search of eating can be presented. Thus, even if no search log is accumulated, an expanded keyword can be presented just after the eating search service starts to be provided.

Incidentally, a plurality of group identifiers can be preset, as it is generally known that a plurality of URLs belongs to one field.

Incidentally, according to an embodiment, the linked URL clicked on the search result page 520 is not treated as input data as to the choice of an expanded keyword. This fact means that the expanded keyword choosing unit 15 is enabled to choose an expanded keyword (the process of and after the operation S402) on obtaining the basic keyword. Thus, the expanded keyword chosen in accordance with an embodiment can be provided to the client terminal 20, e.g., in a following way.

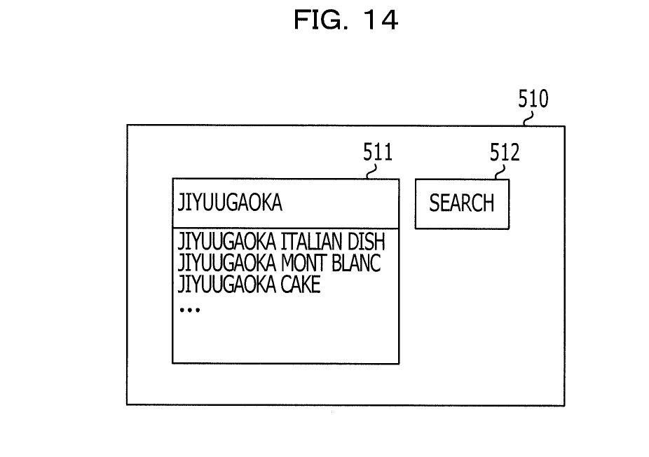

FIG. 14 illustrates an exemplary method of an embodiment for providing an expanded keyword.

FIG. 14 illustrates an example such that candidates for an expanded keyword are displayed upon the word “Jiyuugaoka” being input in the keyword input area 511. In response to the input of the character string in the keyword input area 511 in this case, the script integrated in the search page 510 transmits to the search server 10 a request for obtaining an expanded keyword for the character string. The search server 10 carries out the process illustrated in FIG. 13 in response to the request for obtaining an expanded keyword. The request for obtaining an expanded keyword in this case corresponds to the operation S401 illustrated in FIG. 13. Then, the search server 10 transmits a chosen expanded keyword back to the script. The script displays the received expanded keyword as a candidate for choice.

Incidentally, the area to be searched (the group identifier to limit the area from which the expanded keyword is obtained) need not be fixed to one field in advance. It is acceptable that a plurality of fields is set, that the user can choose a field to be searched, e.g., and that the area from which the expanded keyword is obtained is limited on the basis of the group identifier according to the chosen field.

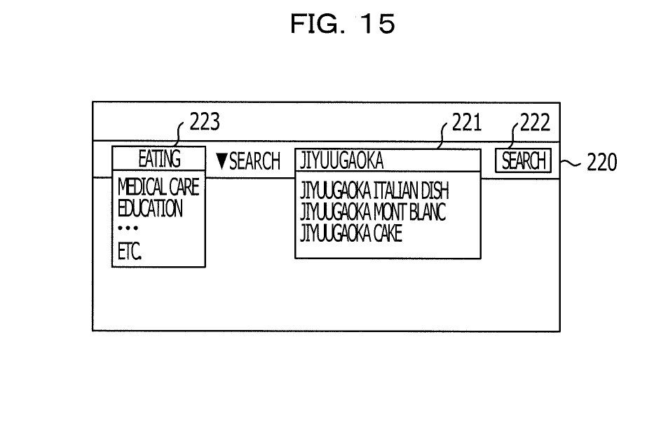

FIG. 15 illustrates an exemplary user interface which enables a user to choose a field to be searched.

In FIG. 15, a toolbar 220 is, e.g., an exclusive toolbar of the search server 10 and is plugged in the Web browser. The toolbar 220 has a keyword input area 221 and a search button 222, and a field choice area 223 as well. The user is enabled to choose a field to be searched in the field choice area 223.

If a field is chosen in the field choice area 223, the toolbar 220 transmits an identifier of the chosen field to the search server 10. The search purpose identifying unit 14 obtains a group identifier on the basis of the received identifier by means of the auxiliary storage device 102. That is, data of connection between the identifier of the field and the group identifier (the particular portion of the URL) (i.e., data of connection between the fields and the groups) is stored in the auxiliary storage device 102. Incidentally, the connection between the fields and the groups can be on a multiple-to-multiple basis. The group identifier is obtained as described above, and is used at the operation S403 illustrated in FIG. 13.

Incidentally, the employment of the toolbar 220 can ease a restriction on the search engine. To put it specifically, a use of a generally used search engine except for the search server 10 (called the “search engine G” hereafter) is facilitated. That is, the toolbar 220 can suitably transmit a search request to the search engine G in response to a press on the search button 222. In that case, the search engine G can be made do a search including the expanded keyword presented by the toolbar 220. The search engine G can resultantly be made more convenient. A search result obtained by the search engine G is displayed on the Web browser. Incidentally, another one can be suitably chosen from a plurality of search engines on the toolbar 220.

According to an embodiment, as described above, there can be better chance of presenting an expanded keyword matching the user's purpose of the search rather than after the retrieval is executed, the expanded keyword is presented.

Then, an embodiment will be explained. This embodiment is a modification of the above-described embodiment. The search server 10 of the above-described embodiment classifies search logs into groups on the basis of a formal common feature of the linked URLs (common feature of character strings). In this case, even URLs belonging to a same field but having no portions which formally agree with each other are classified into different groups. Thus, granularity or an area of a group can possibly be narrowed down too much. This fact means that an area in which an expanded keyword is obtained can possibly be narrowed down too much. Thus, an embodiment discloses how to treat the URLs having no portions which formally agree with each other but meeting particular condition as belonging to a substantially same group.

The particular condition is that the URLs are linked on the basis of the same search result page 520. That is, the user often repeats operations such as clicking a link displayed on the result page 520 and returning, and clicking another link and returning. There is a good chance that the linked URLs operated in such a way represent a common feature in data even if the URLs are formally different from each other. Thus, the search server 10 of an embodiment classifies a set of search logs of a plurality of linked URLs based on the same search result page 520 (same search) into a same group. Incidentally, a set of search logs of an embodiment to be classified on the basis of different group identifiers is called a “group” for convenience of an embodiment. Further, a combination of groups substantially treated as a same group is called a “group set”. Further, what is not mentioned in particular as to an embodiment can be the same as what is mentioned as to the above-described embodiment.

A procedure of a process by means of the search server 10 of an embodiment will be explained below. The procedure of the process of an embodiment for recording and classifying search logs can be same as that of the above-described embodiment (FIG. 3, FIG. 7). The search log storing unit 17 and the classified search log storing unit 18 are partially different, however, from those of the above-described embodiment.

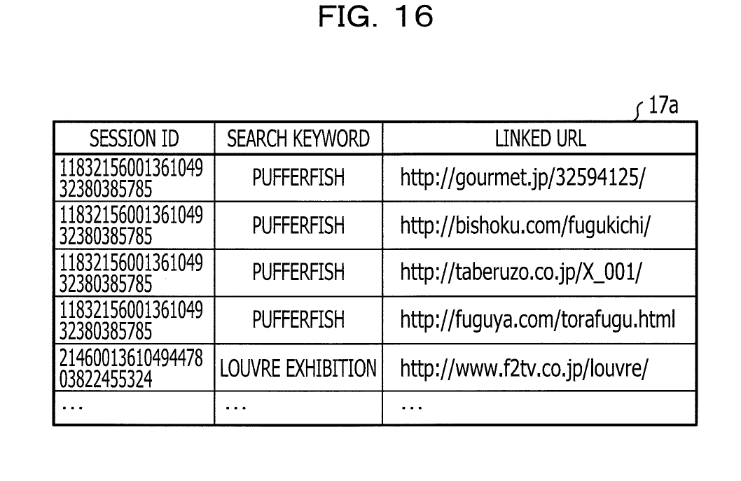

FIG. 16 illustrates an exemplary configuration of a search log storing unit of an embodiment. As illustrated in FIG. 16, the search log storing unit 17a of an embodiment further has an item (column) of the session ID. That is, for every search log, the session ID included in the request for obtaining data which causes the search log to be recorded is recorded on the search log storing unit 17a. A fact that search logs have a common combination of the session ID and the search keyword means that they are search logs in connection with the requests for obtaining data based on the clicks on the links on the same search result page 520. Thus, in FIG. 16, the search logs in the upper four rows correspond to a request for obtaining data based on the search result page 520 indicating results searched for by means of a search keyword “pufferfish”.

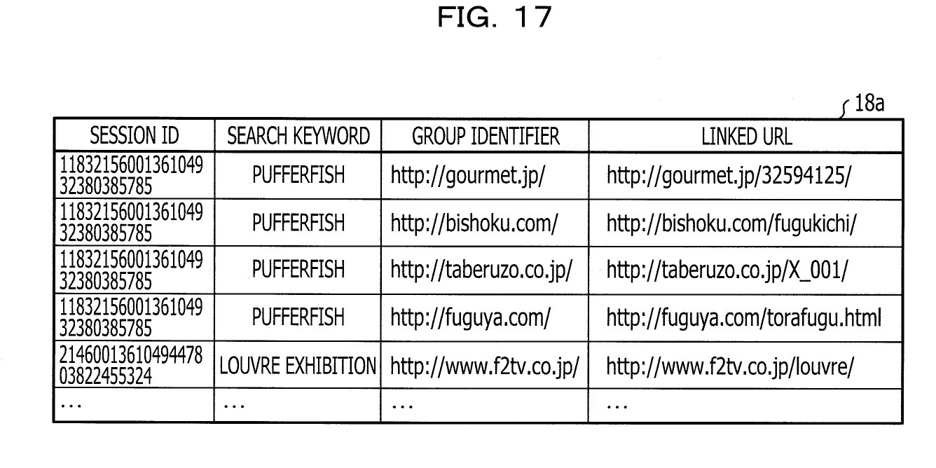

Further, FIG. 17 illustrates an exemplary configuration of a classified search log storing unit of an embodiment. The classified search log storing unit 18a of an embodiment takes over the session ID recorded on the search log storing unit 17a as it is.

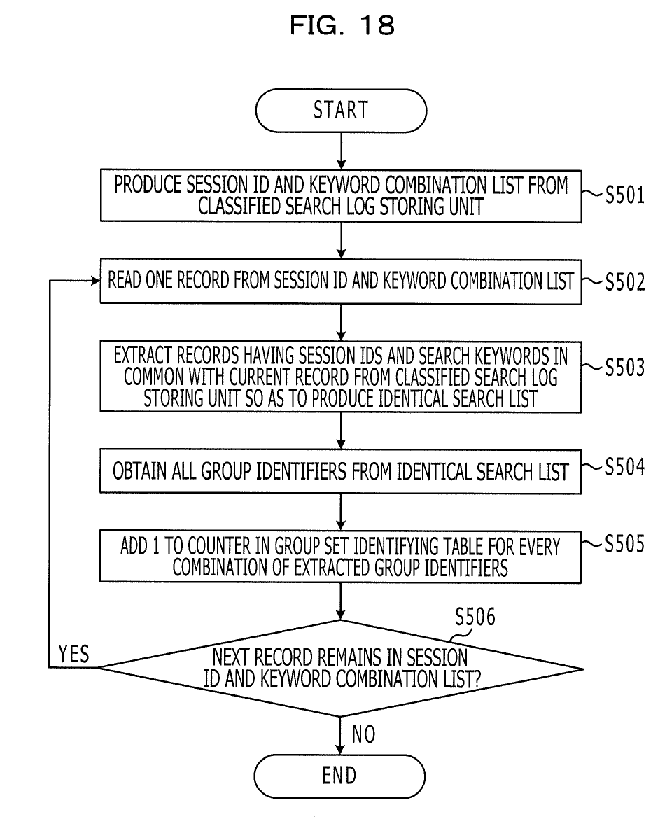

After the classified search log storing unit 18a is produced as illustrated in FIG. 17, a process illustrated in FIG. 18 is carried out. FIG. 18 is a flowchart for illustrating a procedure of a process of an embodiment for classifying a group set.

The search log classifying unit 12 extracts every combination of the session ID and the search keyword from the classified search log storing unit 18a, and records what is extracted as a session ID and keyword combination list on the memory device 103 (S501). In other words, every search log recorded on the classified search log storing unit 18a having a common combination of the session ID and the search keyword is formed as one record in the session ID and keyword combination list.

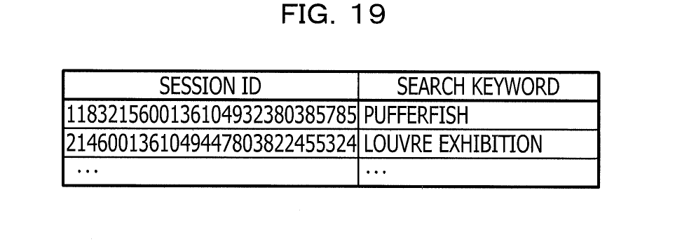

FIG. 19 illustrates an exemplary session ID and keyword combination list. The session ID and keyword combination list illustrated in FIG. 19 is exemplarily produced on the basis of the classified search log storing unit 18a illustrated in FIG. 17. That is, portions of records to which the session ID and the search keyword are common (the session ID and the search keyword) is recorded as one record in the session ID and keyword combination list.

Then, the search log classifying unit 12 obtains one record from the session ID and keyword combination list (S502). One record, e.g., can be suitably obtained in descending order of arrangements in the session ID and keyword combination list. The obtained record is called the “current record” hereafter. Then, the search log classifying unit 12 obtains all records having session IDs and search keywords in common with the current record from the classified search log storing unit 18a, and records what is obtained as an identical search list on the memory device 103 (S503).

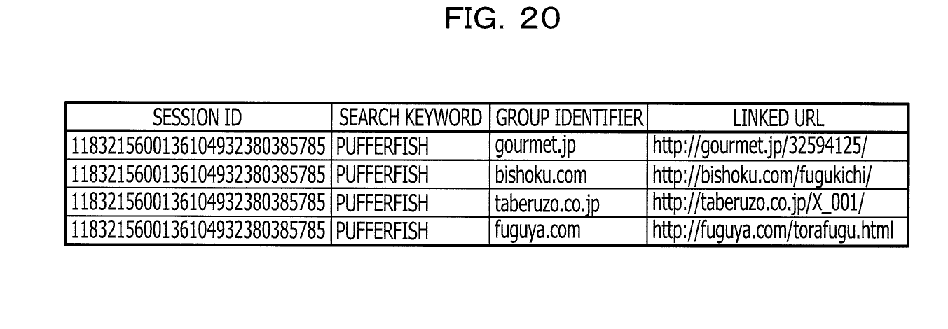

FIG. 20 illustrates an exemplary identical search list in which all logs are extracted as to which data is requested to be obtained (page jump) after a search is done by means of the search keyword “pufferfish”.

Then, the search log classifying unit 12 obtains group identifiers of all the search logs from the produced identical search list (S504). Thus, the group identifiers “gourmet.jp”, “bishoku.com”, “taberuzo.co.jp” and “fuguya.com” are obtained from the identical search list illustrated in FIG. 20. Then, the search log classifying unit 12 adds 1 to a counter in a group set identifying table for every combination of two of the obtained group identifiers (S505).

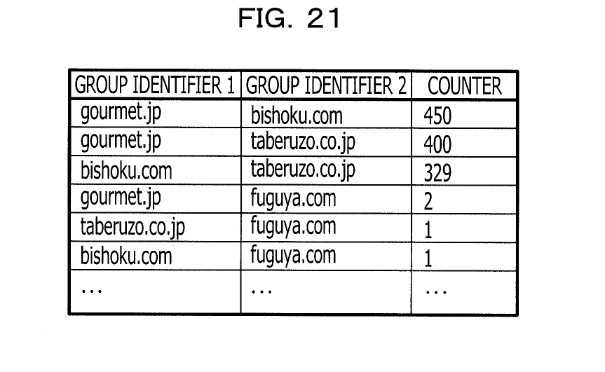

FIG. 21 illustrates an exemplary configuration of the group set identifying table. As illustrated in FIG. 21, a counter is recorded for every combination of two of the group identifiers in the group set identifying table. Add 1 to the counter for a combination having been registered in the group set identifying table (S505).

Meanwhile, a combination not having been registered in the group set identifying table is registered anew in the group set identifying table and 1 is added to the counter. Thus, a large counted value indicates that the URLs including the group identifier of the relevant combination are chosen as linked URLs from the same search result page 520 a lot of times (frequently).

Then, if an unprocessed record (next record) remains in the session ID and keyword combination list (Yes of S506), the search log classifying unit 12 repeats the process of and after the operation 5502. If the process is completed for all the records included in the session ID and keyword combination list (No of S506), the process illustrated in FIG. 18 is completed.

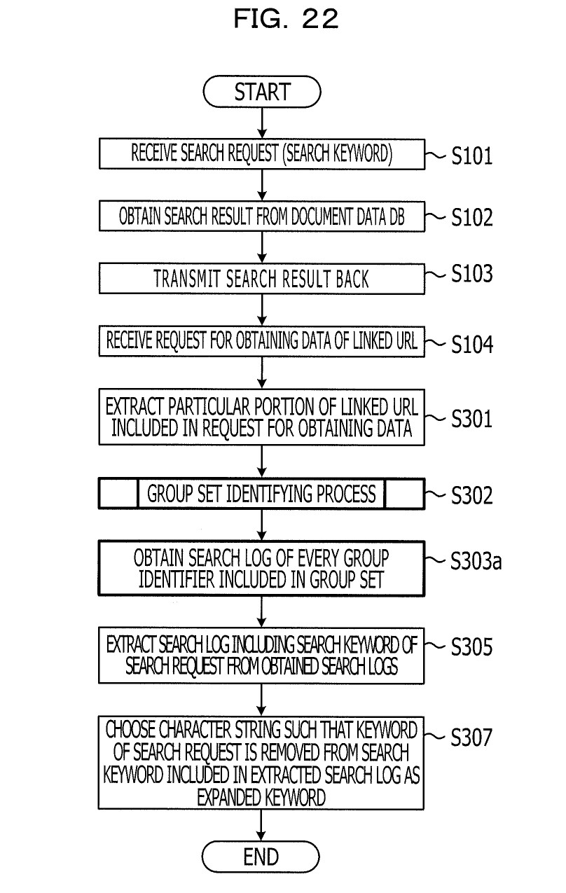

Further, a process illustrated in FIG. 22, rather than FIG. 9, is carried out for an embodiment. FIG. 22 is a flowchart for explaining a procedure of a process of an embodiment for choosing an expanded keyword. Each of operations illustrated in FIG. 22 which is a same as the corresponding one illustrated in FIG. 9 is given a same operation's numeral, and its explanation is omitted.

The process illustrated in FIG. 22 includes the operation S301 followed by a group set identifying process to be carried out (S302). According to the group set identifying process, a group set (a set of one group identifier or a plurality of group identifiers) which corresponds to the particular portion of the linked URL extracted at the operation S301.

The expanded keyword choosing unit 15 obtains, for every group identifier which belongs to the group set identified by the group set identifying process, a search log (record) having the group identifier from the classified search log storing unit 18a (S303a). According to the following operations S305 and S307, the same process as explained with reference to FIG. 9 is carried out.

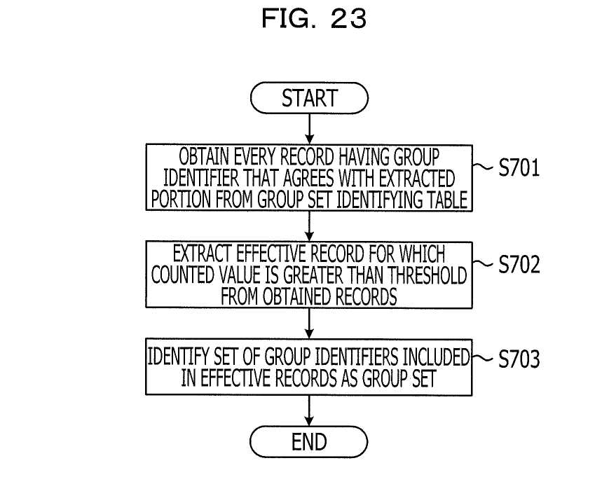

The operation S302 illustrated in FIG. 22 will be explained in detail. FIG. 23 is a flowchart for explaining a procedure of the group set identifying process.

The search purpose identifying unit 14 obtains every record having a group identifier that agrees with the particular portion of the linked URL extracted by the operation S301 illustrated in FIG. 22 from the group set identifying table (refer to FIG. 21). That is, a record for which either one of “group identifier 1” and “group identifier 2” is a same as the particular portion is obtained. If, e.g., the particular portion obtained by the operation S301 is “groumet.jp”, three records on the first, second and fourth rows on the group set identifying table illustrated in FIG. 21 are obtained (S701).

The search purpose identifying unit 14 extracts, from the obtained records, a record for which the counted value is greater than a threshold as an effective record. If, e.g., the threshold is 20, the first and second ones of the three records obtained from the group set identifying table illustrated in FIG. 21 are extracted as effective records (S702).

The search purpose identifying unit 14 identifies all the group identifiers included in “group identifier 1” or “group identifier 2” of the extracted effective records as group identifiers included in a same group set (S703). The group identifiers of the effective record on the first row of the group set identifying table illustrated in FIG. 21 are, e.g., “gourmet.jp” and “bishoku.com”. Further, the group identifiers of the effective record on the second row are “gourmet.jp” and “taberuzo.co.jp”. Thus, a set of groups in connection with the three group identifiers “gourmet.jp”, “bishoku.com” and “taberuzo.co.jp” are identified as a group set.

According to an embodiment, as described above, the search logs classified into three groups in accordance with the above-described embodiment can be treated as what belong to one group set (substantially, one group). The area in which expanded keywords are searched for can resultantly be expanded, so that further more candidates for expanded keywords can be chosen and presented.

Incidentally, the expanded keyword is different from the basic keyword, and is not limited to a word included in the basic keyword. The expanded keyword includes, e.g., a word or a character string that is added to the end of the basic keyword and integrated with the basic keyword so as to form one word. If, e.g., a search keyword “Jiyuugaoka” is expanded to “Jiyuugaoka-sushi”, a word such as “Jiyuugaoka-sushi” is to be extracted.

If the interpretation of the expanded keyword is stretched as described above, the expanded keyword choosing unit 15 expands what is extracted for extracting a search log including a basic keyword at the operation S305 illustrated in FIG. 3, etc. That is, the expanded keyword choosing unit 15 extracts a search log that includes a word matching the basic keyword on a right-truncated basis in the search keyword, as well as a search log that includes the basic keyword in the search keyword as an independent word. As a result, if the basic keyword is “Jiyuugaoka”, a word such as “Jiyuugaoka-sushi” is to be extracted. At the following operation S307, the expanded keyword choosing unit 15 removes the basic keyword (e.g., “Jiyuugaoka”) from the search keyword (e.g., “Jiyuugaoka-sushi”) included in the search log extracted by the right truncation, so as to record the remaining character string (e.g., “sushi”) on the memory device 103. Incidentally, every expanded keyword can suitably be provided with data indicating whether the expanded keyword was input separately from the basic keyword or input with the basic keyword as one. It can thereby be identified whether the expanded keyword should be presented separately from the basic keyword or with the basic keyword as one.

A method and system of supporting a search are provided. A method according to an embodiment includes classifying search logs resulting from searches based on a common feature of linked uniform resource locators and a respective search keyword and displaying a search keyword from the log as a candidate for selection in response to an input of a request. The request may be modified by the selection from the displayed candidate(s) to cause a search of the modified request to be performed.

The embodiments of the disclosed art have been described above in detail. The disclosed art is not limited to such particular embodiments, and can be variously changed or modified within the scope described as claims.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc—Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention, the scope of which is defined in the claims and their equivalents.

What is claimed is:

1. A search supporting device, comprising:
an accepting unit for accepting an input word and a URL;
a log obtaining unit for obtaining from a search log storing unit a log including a search word having been used for every URL of viewed data for a search of the data, the log including a URL having a particular portion in common with the accepted URL and a search word having a particular portion in common with the accepted input word; and
an outputting unit for outputting the search word included in the obtained log.

2. The search supporting device according to claim 1, comprising:
a search unit for transmitting a search result including a URL searched for based on a search word included in a search request upon receiving the search request, and
wherein the accepting unit is configured to accept a URL transmitted based on the search result, and the URL is chosen on the search result.

3. The search supporting device according to claim 1, comprising:
a search log classifying unit for classifying the log individually stored in the search log storing unit based on a common feature of the particular portion of the URL included in the log, the search log classifying unit being configured to record the classified log in a classified log storing unit in connection with the particular portion, and
wherein the log obtaining unit is configured to obtain the log including the URL having the particular portion in common with the accepted URL from the classified log storing unit.

4. The search supporting device according to claim 1, comprising:
a search purpose identifying unit for recording a number of times the particular portion of the accepted URL is common, and
wherein the log obtaining unit is configured to obtain the log including the URL having the particular portion in common with the accepted URL for which the number of times is greater than a threshold.

5. The search supporting device according to claim 1, wherein the search log storing unit stores a common identifier in connection with every set of a plurality of the logs concerning data viewed based on a same search; and
the log obtaining unit obtains a first log including the URL having the particular portion in common with the accepted URL,
the log obtaining unit is configured to obtain the log which belongs to the set, and the log is equal to the first log.

6. The search supporting device according to claim 5, wherein the log obtaining unit obtains the first log and a plurality of the logs which belong to the set of a greater number than a threshold, and the logs is equal to the first log.

7. A method for search supporting, comprising:
accepting an input word and a URL;
obtaining a log including a search word having been used for every URL of viewed data for a search of the data, the log including a URL having a particular portion in common with the accepted URL and a search word having a particular portion in common with the accepted input word; and
outputting the search word included in the obtained log.

8. The method for search supporting according to claim 7, comprising:
transmitting a search result including a URL searched for based on a search word included in a search request upon receiving the search request; and
accepting a URL transmitted based on the search result, the URL being chosen on the search result.

9. The method for search supporting according to claim 7, comprising:
classifying, the log individually stored in the search log storage based on a common feature of the particular portion of the URL included in the log, so as to record the classified log in a classified log storing unit in connection with the particular portion; and
obtaining the log including the URL having the particular portion in common with the accepted URL from the classified log storing unit.

10. The method for search supporting according to claim 7, comprising:
recording a number of times the particular portion of the accepted URL is common; and
obtaining the log including the URL having the particular portion in common with the accepted. URL for which the number of times is greater than a threshold.

11. The method for search supporting according to claim 7, comprising:
storing a common identifier in connection with every set of a plurality of the logs concerning data viewed based on a same search;
obtaining a first log including the URL having the particular portion in common with the accepted URL; and
obtaining the log which belongs to the set, the log being equal to the first log.

12. The method for search supporting according to claim 11, comprising:
obtaining the first log and a plurality of the logs which belong to the set of a greater number than a threshold, the logs being equal to the first log.

13. A method of supporting a search, comprising:
classifying search logs resulting from searches based on a common feature of linked uniform resource locators and a respective search keyword; and
displaying a search keyword from the log as a candidate for selection in response to an input of a request.
